(19) United States
(12) Patent Application Publication
(10) Pub. No.: US 2022/0100857 A1
(43) Pub. Date: Mar. 31, 2022

(54) Systems and Methods of Anomalous Pattern Discovery and Mitigation

(71) Applicant: Elasticsearch B.V., Mountain View, CA (US)

(72) Inventors: Robert Filar, Alexandria, VA (US); David French, Severance, CO (US)

(21) Appl. No.: 17/035,043

(22) Filed: Sep. 28, 2020

(51) Int. Cl. G06F 21/56; G06F 16/901; G06N 20/00

(52) U.S. Cl. CPC G06F 21/566; G06F 2221/034; G06N 20/00; G06F 16/9024

(57) ABSTRACT

Systems and methods of anomalous pattern discovery and mitigation are disclosed herein. An example method includes creating a graph of processes performed by a computer system using edges of the processes and metadata including properties or artifacts of the edges or processes, the edges identify a connection between a parent process and a child process, and detecting anomalous parent-child process chains of the processes by assigning edge weights to the edges of the processes using a supervised learning process that has been trained to identify malicious edges and benign edges to create a weighted graph, the edge weights including predicted class probabilities that are indicative of the processes being malicious, and performing community detection on the weighted graph using an unsupervised learning technique to identify the anomalous parent-child process chains.

### CROSS-REFERENCE TO RELATED APPLICATIONS

N/A.

### TECHNICAL FIELD

This disclosure relates to the technical field of cybersecurity, and more specifically, but not by limitation to systems and methods of anomalous pattern discovery and mitigation that evaluates parent-child process chains using supervised and unsupervised learning.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

According to one example embodiment of the present disclosure, a method includes creating a graph of processes performed by a computer system using edges of the processes and metadata comprising properties or artifacts of the edges or processes, the edges identify a connection between a parent process and a child process; and detecting anomalous parent-child process chains of the processes by assigning edge weights to the edges of the processes using a supervised learning process that has been trained to identify malicious edges and benign edges to create a weighted graph, the edge weights comprising predicted class probabilities that are indicative of the processes being malicious, and performing community detection on the weighted graph using an unsupervised learning technique to identify the anomalous parent-child process chains.

According to one example embodiment of the present disclosure, a method includes creating a graph of processes performed by a computer system using edges of the processes and metadata comprising properties or artifacts of the edges or processes, the edges identify a connection between a parent process and a child process; and detecting anomalous parent-child process chains of the processes by: assigning edge weights to the edges of the processes using a supervised learning process that has been trained to identify malicious edges and benign edges to create a weighted graph, the edge weights comprising predicted class probabilities that are indicative of the processes being malicious; performing community detection on the weighted graph using an unsupervised learning technique to identify the anomalous parent-child process chains and determine a structure of a grouped attack technique of the anomalous parent-child process chains; and generating an anomalous score for a parent-child process chain by combining a predicted class probability with a prevalence score that is indicative of how often a child process has been encountered as compared to other child processes relative to a parent process.

According to one example embodiment of the present disclosure, a system includes a responder comprising a processor; and memory for storing instructions, the processor executes the instructions to create a graph of processes performed by a computer system using edges of the processes and metadata comprising properties or artifacts of the edges or processes, the edges identify a connection between a parent process and a child process, and detect anomalous parent-child process chains of the processes by assigning edge weights to the edges of the processes using a supervised learning process that has been trained to identify malicious edges and benign edges to create a weighted graph, the edge weights comprising predicted class probabilities that are indicative of the processes being malicious, and performing community detection on the weighted graph using an unsupervised learning technique to identify the anomalous parent-child process chains.

### BRIEF DESCRIPTION OF DRAWINGS

Exemplary embodiments are illustrated by way of example and not limitation in the figures of the accompanying drawings, in which like references indicate similar elements.

FIG. 1 is a block diagram of an example environment suitable for practicing methods for secure probabilistic analytics using an encrypted analytics matrix as described herein.

FIG. 2 diagrammatically illustrates an example process event data ingestion, graphing, and output process.

FIG. 3 is a flowchart of an example method of the present disclosure.

FIG. 4 is a flowchart of an example method of the present disclosure related to prevalence analyses.

FIG. 5 is a flowchart of another example method of the present disclosure.

FIG. 6 is a computer system that can be used to implement various embodiments of the present disclosure.

### DETAILED DESCRIPTION OF EXEMPLARY EMBODIMENTS

### Overview

The present disclosure pertains to cybersecurity, and in some embodiments, to systems and methods that are configured to provide cyber-attack detection using graphic analysis and machine learning (both supervised and unsupervised learning). Broadly, these systems and methods allow for the detection of malicious activity in the context of computing processes, and more specifically parent-child process chains. These systems and methods can identify difficult to detect attacks such as living-off-the-land attacks.

For context, it is becoming more common that adversary attacks consist of more than a standalone executable or script. Often, evidence of an attack includes conspicuous process heritage or chain that may be ignored by traditional static machine learning models. Advanced attacker techniques, like “living off the land” may appear normal in isolation, but become more suspicious when observed in a parent-child context.

The context derived from parent-child process chains can be used to identify and group malware families, as well as discover novel attacker techniques. Adversaries chain these techniques to achieve persistence, bypass defenses, and execute actions. Traditional heuristic-based detections often generate noise or disparate events that belong to what constitutes a single attack. The systems and methods disclosed herein utilize a graph-based framework to address these issues. The systems and methods disclosed herein apply a supervised learning classifier to derive a weighted graph used to identify communities of seemingly disparate events into larger attack sequences. The systems and methods disclosed herein also apply conditional probability to automatically rank anomalous communities as well as suppress commonly occurring parent-child chains. In combination, this framework can be used by analysts to aid in the crafting or tuning of detectors and reduce false-positives over time.

To meet the evolving threat of adversary techniques, Traditional Anti-Virus (AV) leveraged signatures to capture known malicious binaries. Over time this created an arms race between attacker and defender that saw most AVs augment signatures with machine learning in hopes of generalizing previously observed malware against the unknown and Next-Generation Anti-Virus (NGAV) was born. The use of machine learning (ML) to detect and prevent malicious binaries has seen a meteoric rise within the security industry and has become table stakes for endpoint protection platforms. The relative success of this approach at stopping novel attacks with “zero-day” malware infections becoming less commonplace has caused sophisticated adversaries to shift their tactics and techniques.

In June 2017 a new ransomware variant called Petya[17] was first observed in the wild as it hit a variety of organizations worldwide (primarily focused on Ukrainian companies). Petya leverages a Server Message Block (SMB) vulnerability made popular by the ransomware family WannaCry. Unlike WannaCry, Petya leveraged a series of system-level commands to gain a foothold and establish persistence. These commands provide a “benign” capability to perform credential dumping, execution of itself, setting a scheduled task, and wiping logs. Petya performed all of these tasks using the tools provided by the operating system like Windows Management Instrumentation (WMI) command-line tool wmic.exe and task scheduler tool schtasks.exe. Tactics like these are called “Living off the land” and represent the next great challenge in securing the endpoint as attackers rely heavily on dual-use software to execute their attacks and “hide in plain sight” on the operating system.

As noted above, the systems and methods disclosed herein implement a graph-based framework designed to address the concerns listed above. The systems and methods disclosed herein ingest process Event Tracing for Windows data (ETW) and expose an intuitive interface to address technical challenges in the detection of living off the land techniques, specifically anomalous or rare parent-child relationships. In some embodiments, the systems and methods involve training a machine learning model on a large set of malicious and benign event data targeting features from process creation events, providing an anomaly score that accounts for the prevalence of a parent-child process pair within the local environment against the output of an ML model. This score becomes the edge weight between a parent and child node in a directed graph. Community detection can be applied to segment the weighted graph into smaller “chains” of processes. In some embodiments, a threshold can be applied against each community to determine if it's overall score is anomalous and return a ranked list of potentially malicious communities.

These systems and methods can reduce a large set of process-related events to a manageable list of rank-ordered rare parent-child process chains, suppressing commonly occurring, but previously unobserved activity. It will be understood that ranking or prioritizing events has been shown to help reduce noise in an environment.

Living off the Land Binaries are Microsoft-signed binaries that come pre-installed on the operating system. These pieces of software have alternative or unexpected features outside of their core functionality. For example, the binary schtasks.exe allows an administrator to create, delete, query, change, run, and end scheduled tasks on a local or remote computer. However, this binary may also be leveraged by an attacker to bypass User Account Control (UAC) and escalate privileges. The use of these binaries reduces the number of new files dropped to disk during an attack and lessens the chance of being detected by security software.

Attackers may also chain these binaries together to perform more sophisticated actions that mimic traditional adversary attack sequences. Incursion: Initial access vector either exploiting a Remote Code Execution (RCE) vulnerability or targeted individuals using a spear-phishing attack. Persistence: Post-compromise actions to allow the attacker to maintain a presence on system. Payload: Employs dual-use tool (e.g. psexec or mimikatz) or fileless capability to execute the rest of the attack.

The use of these binaries makes the discovery of an attack much more difficult as adversary behavior is mixed in with traditional benign operating system activity. Historically, APT groups and other threat actors were identifiable based on the custom binaries they left behind. By using benign OS binaries attribution becomes that much more difficult. After all, these binaries will not be detected by AV engines and there is no exploit taking place. For security vendors, this means exploring alternative data streams like ETW and attempting to derive anomalous or suspicious event sequences based on the file, process, DNS, or security-related events.

Existing solutions used to combat these techniques revolves around developing a rule or heuristic to act as a detector for a given technique. Threat researchers have moved to simple, schema independent query languages to craft real-time detectors against streaming data. Language like EQL allows researchers to craft expressive rule-based logic for detecting a specific ATT&CK technique.

This approach has several limiting factors: (1) rules can be prone to false positives because they are based on inherently benign software, 2) noise can contribute to alert deluge common in security software, and 3) generation of rules is a manual process that requires domain expertise and the ability to learn from or across customer environments to tune detectors over time.

The use of system-level entities, like parent-child process chains, has historically been used by security tools to model APT kill chains, establish provenance graphs, or construct dependency graphs for root cause detection. Additionally, there has been research dedicated to the correlation of alert data in an attempt to reduce alert noise, such as alert management and improving the quality and efficacy of alerts. However, applying these approaches in a real-world operation setting can be difficult. Vendors must account for industry, customer, administrator, and user behavior when rolling out a solution. Without careful consideration of environmental factors (e.g. what is normal in an organization?) these detectors may become overly sensitive to a specific attack signature and thus be prone to false-positives.

When applying detectors based on human-derived logic, customization, in any form, requires a monitoring period and an ability to tune a detector. If these detectors are too specific, some attacks will be captured, but they will fail to generalize to previously unseen or novel variants. An iterative tuning approach has proven to be a method for developing detectors. However, the approach above is only made possible by having detection content to write rules against. Frameworks like Atomic Red Team, RTA, and Calder provide a library of scripts that replicate living off the land techniques described in the MITRE ATT&CK matrix.

These frameworks can be executed by technique ID (e.g. T1088—Bypass User Account Control) or, in the case of Atomic Red Team, chained together to replicate real-world adversaries. Additionally, there has been a fair amount of work by these researchers to provide a blue team (defensive) counterpart to their red team ATT&CK frameworks. AtomicBlue, MITRE CAR, Windows Defender ATP Queries have all released repositories of detectors or heuristics that map to ATT&CK techniques in hopes of fostering a community of sharing. While these frameworks are valuable to threat researchers writing detectors they may also be leveraged as a labeled dataset for machine learning applications.

The systems and methods disclosed herein utilize system-level data, primarily process events, extracted from Microsoft ETW data to identify anomalous parent-child process chains and hunt for living off the land attacks. To be sure, these approaches may similarly be applied to Linux (using auditd). Data can be imported in bulk using Sysmon, an open-source collection tool.

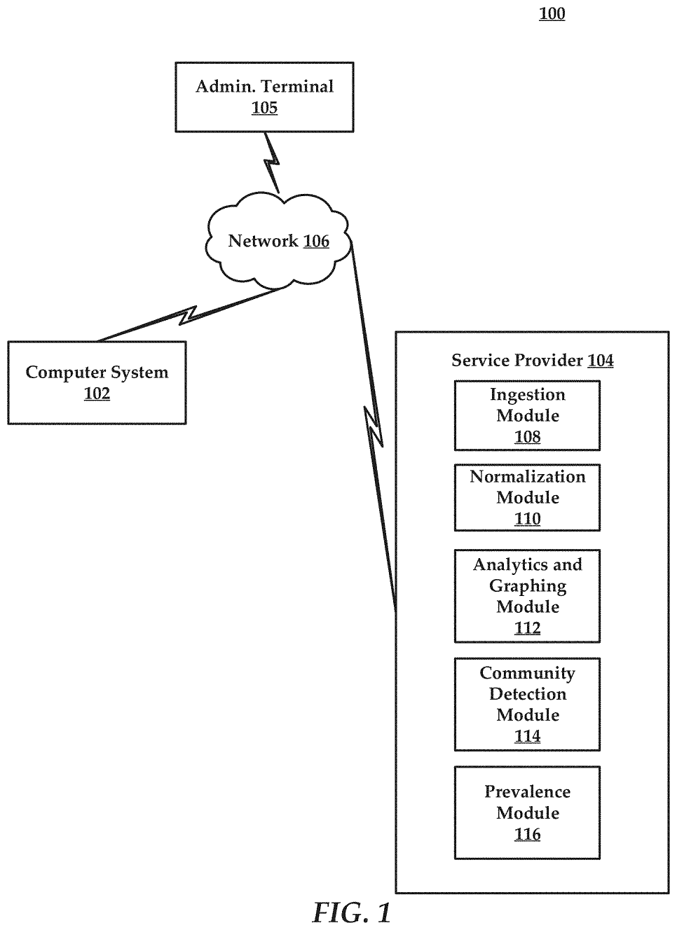

Turning now to the drawings, FIG. 1 depicts an illustrative architecture or illustrative architecture 100 in which techniques and structures of the present disclosure may be implemented. The architecture 100 includes a computer system 102 and a service provider 104. Generally, each of the components of the architecture 100 can include a computer system that is programmed to perform the methods and operations disclosed herein. The components of the architecture 100 can communicate over a network 106. The network 106 can include any public and/or private network that would be known to one of ordinary skill in the art. An administrator terminal 105 can be included that provides administrator access to the output of the service provider 104, such as graphs and anomaly scores, as well as other metrics or output disclosed herein.

The computer system 102 is configured to generate process data, also referred to as event data. The process data can be obtained by the service provider 104 using a data ingestion process. As noted above, the computer system 102 can generate process Event Tracing for Windows data (ETW).

The service provider 104 can comprise various modules or processes that include an ingestion module 108, a normalization module 110, analytics and graphing module 112, a community detection module 114, and a prevalence module 116. To be sure, these modules are set forth descriptive purposes and are not intended to be limiting. The functions of two or more modules may be combined in some instances.

The ingestion module 108 can be configured to provide both data ingestion and data normalization. The ingestion module 108 can transform process data into a numeric representation, which serves two basic functions: (1) it helps reduce resource overhead complexity in storing supplemental data leaving primary data (e.g. process name) intact for graphing operations, and (2) allows the analytic graphing module 112 to learn broader details of the parent-child relationship, in the scope of an attack, which avoids just learning signatures.

As noted above, the service provider 104 can apply a graph-based analytic framework to metadata extracted from each process creation event (e.g., process data) in the following format and stored in graph format: (1) a node, which is indicative of an object or entity being modeled (e.g. process or process name); (2) an edge, which is indicative of an action taken by an object (e.g. process create, fork, terminate, etc.); and (3) metadata, which is indicative of properties or artifacts that describe a node or edge (e.g. process identifier, command-line arguments, timestamps, and so forth).

The ingestion module 108 can obtain process data from sources such as Winlogbeat, Sysmon, osquery, Endpoint sensors, and the like—just to name a few. In general, the ingestion module 108 targets process creation events, where a focus is placed on parent-child process chains.

The normalization module 110 can be executed to normalize the process event data obtained by the ingestion module 108 and transform the normalized data using feature engineering. For example, the ingestion module can obtain the following data such as:

As noted in the example above, a child process and parent process includes both wmiprvSE.exe and svchost.exe. An array is created from both these processes. Command-line arguments can be analyzed using a process such as a term frequency-inverse document frequency analysis (TF-IDF).

Once the process event data have been ingested, normalized and features engineered, the analytics and graphing module 112 can be executed to generate a graph of the process data. In some embodiments, the graph is a directed acyclic graph.

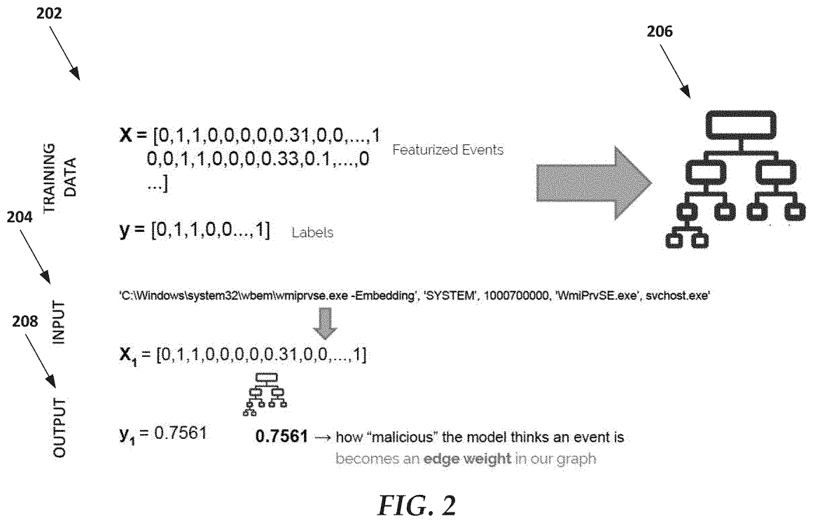

After the analytics and graphing module 112 generates the graph, a series of statistical methods can be applied to draw out anomalous parent-child chains and connect disparate detections based on community detection. FIG. 2 depicts an example process where training data 202 is used to evaluate input 204 created from normalized process data. The input 204 includes a vector of numerical values, in one embodiment. A graph 206 is generated and used along with the input 204 to determine how “malicious” the process data appear to be given the model applied. As noted, the maliciousness is a calculated score or probability value that is used as an edge weight in the graph and is represented by output 208. The calculated maliciousness score could range from 0-100. In this example, the data are assigned a score of 0.7561 or 75.61%. Thus, there is a 75.61% likelihood that these process data, associated with a parent-child process chain are indicative of malicious activity on the computer system 102 (see FIG. 1). Additional details on these scoring and analytics processes are provided infra.

In general, community detection seeks to segment a graph structure based on the relative edge weights between nodes. However, community detection requires a weighting scheme to maximize effectiveness due to the likelihood of a given node (e.g. process) associated with an attack also having connections to benign nodes (e.g. LOLBins benign or primary use cases).

In contrast, the analytics and graphing module 112 uses a technique to provide weight assignments for each edge via supervised learning. One example supervised learning technique includes XGBoost™, an implementation of a gradient boosted trees model. The analytics and graphing module 112 focuses on learning from past malicious and benign process chains to determine a weight correlated with the maliciousness of a given parent-child pair. This becomes a supervised learning problem, that targets the following features to generate a weight for a given edge between (u, v), where u is a child process and v is a parent process. Example features include, but are not limited to: a time difference between creation and termination of a process; one-hot encoding of a child process and a parent process; a determination as to whether the process is signed; a determination as to whether the process is elevated; a determination as to whether the process is running as a system; a parent-child user mismatch; entropy of a process name; entropy of a command-line argument; and/or term frequency-inverse document frequency analysis of the command line argument.

These data points provide a feature vector that can be passed to a XGBoost model that has been trained on labeled malicious edges and benign edges derived from event data. Instead of predicting a binary label, the analytics and graphing module 112 can predict a class probability between 0.0-1.0 for a malicious label and use that number as the weight for a given edge. Again, an edge is a connection between a parent process and at least one child process. The result of this process is a weighted graph. Thus, the graph initially created can have its edges weighted to produce a weighted graph.

The community detection module 114 can execute a community detection process on the weighted graph to segment the weighted graph. An example community detection process can include Louvain community detection. Louvain is an unsupervised learning technique that assigns each node in a graph to a community via a two-step process: (1) “greedy” assignment of nodes to form a community to a neighboring community to calculate changes to modularity; and (2) for each node, determine a maximum change in modularity and place that node into the corresponding community. Again, a node is equivalent to a process.

Community detection should aid in the identification of rare process chains (e.g. attack sequences) and provide a structure for “grouped” attack techniques. A result is a dictionary of node assignments (e.g. unique processes) to a given community.

The prevalence module 116 can be executed to determine how prevalent a process, parent-child chain, or a process-command line is within a local or target environment. The prevalence module 116 can be executed at run-time to apply a series of probability calculations to yield a “weight” to multiply against the output of the XGBoost model. First, the prevalence module 116 provides a query interface to get the prevalence of a process using the following method: Pr(process_count<PERCENTILE).

The score will range between 0 and 99 which represents the percentile of the number of times the process has been seen in the wild. The process prevalence score is indicative of a process being seen more than X % of other processes. Likewise, detecting the prevalence of a parent-child process chain requires a similar calculation, except the conditional probability determination can be performed first, instead of raw counts of a parent-child relationship using: P(child|parent)=P(child, parent)/P(parent).

It will be understood that the output of these equations can range widely. Thus, the prevalence module 116 can apply the same percentile technique as above to ensure a 0-99 score. Thus, the parent process prevalence score becomes Pr(P(child|parent)<PERCENTILE).

The prevalence module 116 can then determine “From this parent process, a child process has been encountered more than X % of other child processes. This interface to the parent-child prevalence score is accessible via a dictionary lookup similar to that of prevalence.

Likewise, other scores can provide visibility into the rarity of encountering a particular process. For example, a process prevalence score can indicate if the process has been encountered more than X % of other processes. In another example, a command-line prevalence can be determined relative to a process. For example, a command-line prevalence score can indicate, concerning a particular process, whether a particular command line has been encountered more than X % of other command lines associated with the process in question.

Prevalence analyses can answer other related questions such as “How rare is this parent-child relationship?”; or “Is it common to see this process with these siblings in a process tree?”. The prevalence analyses can also be used to reduce or rank data. For example, communities of data can be ranked based on prevalence. The prevalence analyses can also be used to suppress false-positive results by focusing on rarer patterns of behavior.

In some embodiments, the community detection module 114 can be used to determine ‘bad’ communities. For example, the community detection module 114 can maximize a malicious_score (global ML view) of a given parent-child process chain by combining it with its prevalence_score (local statistical view) to generate an anomalous_score. The community detection module 114 can perform this calculation for every node in the graph by iterating through each community. Example code for detecting bad communities is provided below:

```
def find_bad_communities(G, threshold ) :
  bad_communities = [ ]
  communities = community_detection(G, weight=weight)
for community in communities: for node in community:
  prevalence_score = prevalence[node.process_name]
  [node.pprocess_name]
node[anomalous_score] = node[weight] * (1-prevalence_score )
if max( [node[anomalous_score]for node in community] ) >= threshold:
bad_communities . append(community)
#return most malicious communities first
return sorted ( bad_communities, reverse=True)
```

To be sure, an input of this function is a weighted graph as disclosed above, relative to a selected threshold value. The output of the function includes a rank-ordered list of bad communities. In more detail, the community detection module 114 can perform a maximum function across all the anomaly scores for nodes in a given community. If the returned value is >=a specified threshold, the community is deemed malicious and set aside for user review. Upon completing this action for each community in the graph the list of malicious communities is rank-ordered to return the highest scored communities first and suppress commonly occurring parent-child process chains. This process can drastically reduce the amount of data and threat researchers have to work with and limit the creation of noisy detectors.

In an example use case, the supervised learning model is trained on a combination of real-world and simulated benign and malicious data. Benign data includes three (3) days of internal Endgame ETW process data. The sources of this data can include a mix of user workstations and servers to replicate a small organization. Malicious data can be generated by detonating all (or some of) the ATT&CK techniques available via the Endgame RTA framework, as well as launching macro and binary based malware from advanced adversaries like FIN7 and Emotet. This combined dataset can be used to train the XGBoost model mentioned above.

The evaluation data can be comprised of two additional days of internal Endgame ETW process data (benign) and Atomic Red Team attack data, plus APT3 data that simulates the 2018 MITRE ATT&CK evaluation (malicious). The data was collected using Windows SysInternals Sysmon.

Thresholds, as noted above, can be determined using a leave-one-out (LOO) retraining. For example, a LOO retraining can be used as a method to determine an ideal threshold of malicious communities. An example method can include retraining a classifier on all but one subset of the training data and then evaluating the holdout to produce false-positive rate (FPR) and false-negative rate (FNR) for a given model. For example, a classifier can be trained on all data, but one day of benign data from machine A gathered performance metrics by evaluating the model against the held-out data and moved on to repeat the process against data from machine B. Upon completion of this process an ideal threshold can be determined in order to maintain an FPR<1% was 0.38. An example ROC curve is provided below:

It has been noted that the primary cause of false-positives is due to an admin machine that leveraged PowerShell scripting for various tasks (e.g. pushing out updates, automation, etc.). Likewise, false-negatives were largely attributed to attack chains that had a single parent-child process event followed by file, registry, and network events.

An experiment was presented as a blue team post-mortem exercise. In this case, a red team executed a series of sophisticated attacks that melded together multiple techniques from the ATT&CK matrix. Event data from the 2018 MITRE ATT&CK was used. Evaluation was provided by Cyb3rWardOg's Mordor project. The ATT&CK Evaluation sought to emulate APT3 activity using FOSS/COTS tools like PSEmpire and CobaltStrike. These tools allow living off the land techniques to be chained to perform Execution, Persistence, or Defense Evasion tasks.

The results of the evaluation were performed for APT3 group which represents a Chinese-based threat actor associated with China's Ministry of State Security. The primary target(s) of APT3 campaign had been the US, but in mid-2015 the group shifted focus to political organizations in Hong Kong. APT3 was emulated for the 2018 ATT&CK Evaluation because of its robust, and diverse, post-exploitation tradecraft which relies heavily on living off the land techniques. While this experiment was an ambitious test of the capabilities of the architecture there are inherent shortcomings with the setup. First, there is limited user noise in the environment. Second, since the machines were not actively used during the exercise, the adversary activity is unrealistically loud. Nevertheless, this is a valid test of our framework due to the sophistication and diversity of techniques employed.

Overall, the systems and methods disclosed herein were able to recognize a group of ATT&CK techniques executed by the (PowerShell) Empire Project. For example, a system of the present disclosure detected PowerShell with unusual arguments which were uncovered a C2 channel using 443 (discovered in b64 encoded arguments).

A system of the present disclosure detected a File Permissions Modification: takeown.exe using PowerShell to obtain ownership of magnify.exe a icacls.exe via PowerShell to modify the DACL for magnify.exe. Likewise, the system of the present disclosure was able to identify anomalous process events associated with System Network Configuration Discovery, Systems Owner/User Discovery, and System Service Discovery. Finally, the value of the prevalence module was demonstrated in suppressing FPs that arose during this scenario and reducing the overall number of process creation events from 50,000 process events down to 40 communities comprising four to six events in each. The data used by the system of the present disclosure can be enhanced using additional forms of data such as DNS record data, registry data, and other data for a computer system that would be recognized by one of ordinary skill in the art.

The use case disclosed above established the propriety of using a graph-based analysis framework for automatically uncovering anomalous process-level events. The application of local prevalence increases the ability for these systems to hone in on rare parent-child chains and connect them to larger attack patterns. While detectors based on heuristics perform well in identifying a singular living off the land technique, it will be understood that there is an opportunity for machine learning to help reduce and rank the event data threat researchers based these detectors on, limiting a deluge of false-positives.

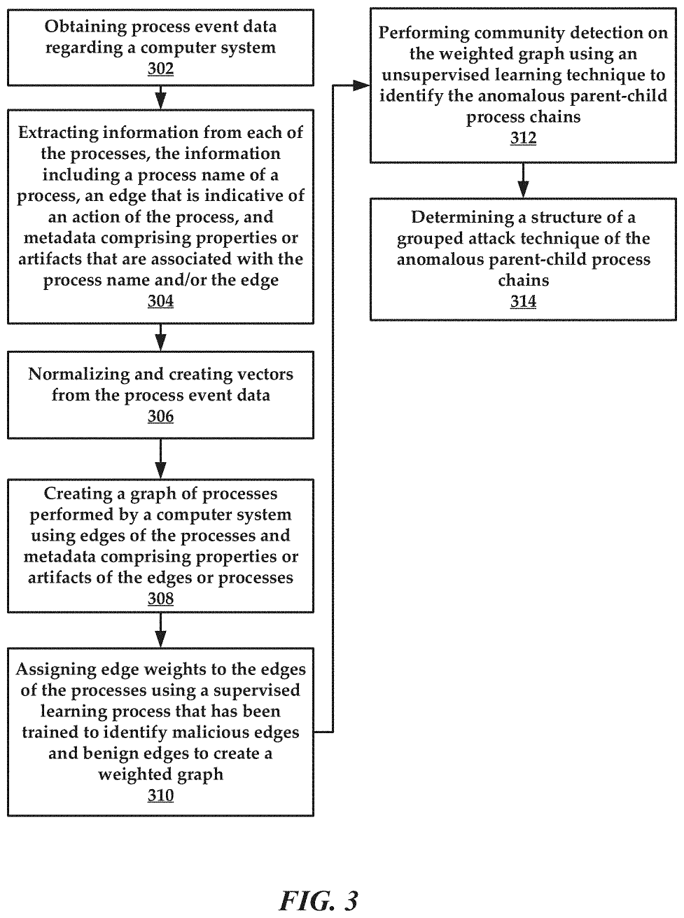

FIG. 3 is a flowchart of an example method of the present disclosure. The method can include a step 302 of obtaining process event data regarding a computer system. Next, the method includes a step 304 of extracting information from each of the processes, the information including a process name of a process, an edge that is indicative of an action of the process, and metadata comprising properties or artifacts that are associated with the process name and/or the edge. These processes can also include functions such as analyzing any combination of a filepath, username, timestamp, an array created from processes, and command-line arguments, as well as applying a term frequency-inverse document frequency analysis of the command line arguments.

Once the data have been extracted and analyzed, the method includes a step 306 of normalizing and creating vectors from the process event data. In some embodiments include utilizing the vectors as input to a graphing process. Thus, the method can include a step 308 of creating a graph of processes performed by a computer system using edges of the processes and metadata comprising properties or artifacts of the edges or processes. As noted above, the edges identify a connection between a parent process and a child process.

In some embodiments, the method includes a process of detecting anomalous parent-child process chains of the processes by performing a step 310 of assigning edge weights to the edges of the processes using a supervised learning process that has been trained to identify malicious edges and benign edges to create a weighted graph. It will be understood that the edge weights comprise predicted class probabilities that are indicative of the processes being malicious. The supervised learning process is a gradient boosted trees model, and the edge weights are assigned by predicting a class probability for the edges that are identified as malicious edges by the supervised learning process.

In one or more embodiments, the method includes a step 312 of performing community detection on the weighted graph using an unsupervised learning technique to identify the anomalous parent-child process chains. The unsupervised learning technique may assign each of the processes using: (1) a greedy assignment of the processes from a community to a neighboring community to determine changes in modularity; and/or (2) for each of the processes, determining a maximum change in the modularity and placing a process of the process into a corresponding community. In some embodiments, the method includes a step 314 of determining a structure of a grouped attack technique of the anomalous parent-child process chains.

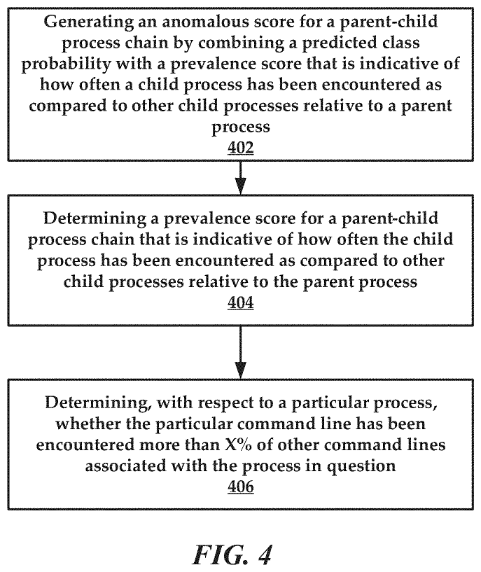

FIG. 4 is a flowchart of an example method. The method can flow from step 212 of FIG. 3 in some embodiments. In general, the method includes a step 402 of generating an anomalous score for a parent-child process chain by combining a predicted class probability with a prevalence score that is indicative of how often a child process has been encountered as compared to other child processes relative to a parent process. The method can include a step 404 of determining a prevalence score for a parent-child process chain that is indicative of how often the child process has been encountered as compared to other child processes relative to the parent process. Other similar questions can be answered using the prevalence scoring related to comparing process in view of command lines, or other metrics. For example, the method can include a step 406 of determining, with respect to a particular process, whether the particular command line has been encountered more than X % of other command lines associated with the process in question.

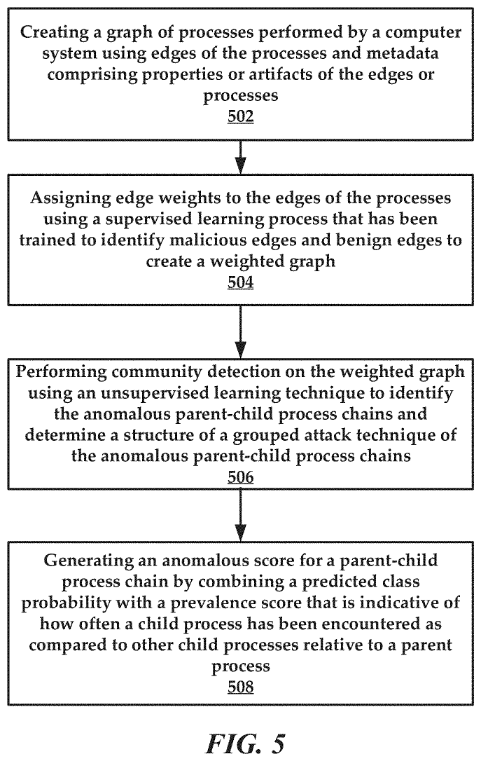

FIG. 5 is yet another flowchart of an example method. The method can include step 502 of creating a graph of processes performed by a computer system using edges of the processes and metadata comprising properties or artifacts of the edges or processes. To be sure, the edges identify a connection between a parent process and a child process. The method can further include a process of detecting anomalous parent-child process chains of the processes by a step 504 of assigning edge weights to the edges of the processes using a supervised learning process that has been trained to identify malicious edges and benign edges to create a weighted graph. Again, the edge weights comprise predicted class probabilities that are indicative of the processes being malicious.

According to some embodiments, the method includes a step 506 of performing community detection on the weighted graph using an unsupervised learning technique to identify the anomalous parent-child process chains and determine a structure of a grouped attack technique of the anomalous parent-child process chains. The method can also include a step 508 of generating an anomalous score for a parent-child process chain by combining a predicted class probability with a prevalence score that is indicative of how often a child process has been encountered as compared to other child processes relative to a parent process.

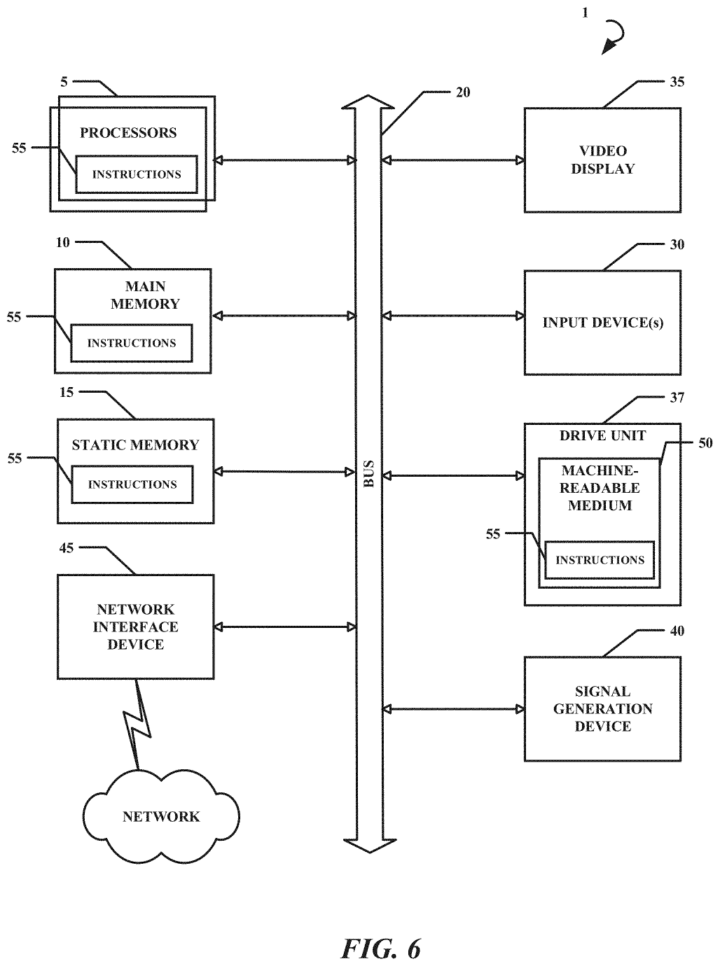

FIG. 6 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

The components provided in the computer system 1 are those typically found in computer systems that may be suitable for use with embodiments of the present disclosure and are intended to represent a broad category of such computer components that are well known in the art. Thus, the computer system 1 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, the computer system 1 may be implemented as a cloud-based computing environment, such as a virtual machine operating within a computing cloud. In other embodiments, the computer system 1 may itself include a cloud-based computing environment, where the functionalities of the computer system 1 are executed in a distributed fashion. Thus, the computer system 1, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computer device 1, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The foregoing detailed description includes references to the accompanying drawings, which form a part of the detailed description. The drawings show illustrations in accordance with exemplary embodiments. These example embodiments, which are also referred to herein as “examples,” are described in enough detail to enable those skilled in the art to practice the present subject matter.

The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents. In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method, comprising:
creating a graph of processes performed by a computer system using edges of the processes and metadata comprising properties or artifacts of the edges or processes, the edges identify a connection between a parent process and a child process; and
detecting anomalous parent-child process chains of the processes by:
assigning edge weights to the edges of the processes using a supervised learning process that has been trained to identify malicious edges and benign edges to create a weighted graph, the edge weights comprising predicted class probabilities that are indicative of the processes being malicious; and
performing community detection on the weighted graph using an unsupervised learning technique to identify the anomalous parent-child process chains.

2. The method according to claim 1, further comprising extracting information from each of the processes, the information including a process name of a process, an edge that is indicative of an action of the process, and metadata comprising properties or artifacts that are associated with the process name and/or the edge.

3. The method according to claim 1, further comprising analyzing any combination of a filepath, username, timestamp, an array created from processes, and command line arguments.

4. The method according to claim 3, further comprising applying a term frequency-inverse document frequency analysis of the command line arguments.

5. The method according to claim 1, wherein the graph is a directed acyclical graph.

6. The method according to claim 1, wherein the supervised learning process is a gradient boosted trees model, and the edge weights are assigned by predicting a class probability for the edges that are identified as malicious edges by the supervised learning process.

7. The method according to claim 1, wherein the supervised learning process determines the edge weights from any one or more of:
a time difference between creation and termination of a process;
one-hot encoding of a child process and a parent process;
a determination as to whether the process is signed;
a determination as to whether the process is elevated;
a determination as to whether the process is running as a system;
a parent-child user mismatch;
entropy of a process name;
entropy of a command line argument; and/or
term frequency-inverse document frequency analysis of the command line argument.

8. The method according to claim 1, wherein the unsupervised learning technique assigns each of the processes:
using a greedy assignment of the processes from a community to a neighboring community to determine changes in modularity; and
for each of the processes, determining a maximum change in the modularity and placing a process of the process into a corresponding community.

9. The method according to claim 1, further comprising determining a prevalence score for a parent-child process chain that is indicative of how often the child process has been encountered as compared to other child processes relative to the parent process.

10. A method, comprising:
creating a graph of processes performed by a computer system using edges of the processes and metadata comprising properties or artifacts of the edges or processes, the edges identify a connection between a parent process and a child process; and
detecting anomalous parent-child process chains of the processes by:
assigning edge weights to the edges of the processes using a supervised learning process that has been trained to identify malicious edges and benign edges to create a weighted graph, the edge weights comprising predicted class probabilities that are indicative of the processes being malicious;
performing community detection on the weighted graph using an unsupervised learning technique to identify the anomalous parent-child process chains and determine a structure of a grouped attack technique of the anomalous parent-child process chains; and
generating an anomalous score for a parent-child process chain by combining a predicted class probability with a prevalence score that is indicative of how often a child process has been encountered as compared to other child processes relative to a parent process.

11. The method according to claim 10, further comprising determining a structure of a grouped attack technique of the anomalous parent-child process chains.

12. The method according to claim 10, wherein the supervised learning process determines the edge weights from any one or more of:
a time difference between creation and termination of a process;
one-hot encoding of a child process and a parent process;
a determination as to whether the process is signed;
a determination as to whether the process is elevated;
a determination as to whether the process is running as a system;
a parent-child user mismatch;
entropy of a process name;
entropy of a command line argument; and/or
term frequency-inverse document frequency analysis of the command line argument.

13. The method according to claim 10, wherein the unsupervised learning technique assigns each of the processes:
using a greedy assignment of the processes from a community to a neighboring community to determine changes in modularity; and
for each of the processes, determining a maximum change in the modularity and placing a process of the process into a corresponding community.

14. The method according to claim 13, further comprising applying a term frequency-inverse document frequency analysis of the command line arguments.

15. The method according to claim 14, further comprising determining a prevalence score for a parent-child process chain that is indicative of how often the child process has been encountered as compared to other child processes relative to the parent process.

16. The method according to claim 10, wherein the graph is a directed acyclical graph.

17. The method according to claim 10, wherein the supervised learning process is a gradient boosted trees model, and the edge weights are assigned by predicting a class probability for the edges that are identified as malicious edges by the supervised learning process.

18. A system, comprising:
a processor; and
a memory for storing instructions, the processor executing the instructions to:
create a graph of processes performed by a computer system using edges of the processes and metadata comprising properties or artifacts of the edges or processes, the edges identify a connection between a parent process and a child process; and
detect anomalous parent-child process chains of the processes by:
assigning edge weights to the edges of the processes using a supervised learning process that has been trained to identify malicious edges and benign edges to create a weighted graph, the edge weights comprising predicted class probabilities that are indicative of the processes being malicious; and
performing community detection on the weighted graph using an unsupervised learning technique to identify the anomalous parent-child process chains.

19. The system according to claim 18, wherein the processor is configured to extract information from each of the processes, the information including a process name of a process, an edge that is indicative of an action of the process, and metadata comprising properties or artifacts that are associated with the process name and/or the edge.

20. The system according to claim 18, wherein the processor is configured to:
analyze any combination of a filepath, username, timestamp, an array created from the processes, and command line arguments; and
apply a term frequency-inverse document frequency analysis of the command line arguments.
